(19) United States
(12) Patent Application Publication
(10) Pub. No.: US 2012/0191301 A1
(43) Pub. Date: Jul. 26, 2012

(54) SAFETY DEVICE FOR AN ELECTRIC POWER STEERING SYSTEM

(75) Inventors: Imre Benyo, Budapest (HU); Imre Szepessy, Budapest (HU); Adam Varga, Budapest (HU)

(73) Assignee: ThyssenKrupp Presta AG, Eschen (LI)

(21) Appl. No.: 13/499,540

(22) PCT Filed: Sep. 14, 2010
(86) PCT No.: PCT/EP2010/005615

§ 371 Date: Mar. 30, 2012

(30) Foreign Application Priority Data
Oct. 2, 2009 (DE) 10 2009 048 092.7

(51) Int. Cl. B62D 6/08

(52) U.S. Cl. 701/41

(57) ABSTRACT

The invention relates to a control method for a steering system having electric power assistance, comprising a control means, for example a steering wheel, which can be controlled by a driver, an electric power assist motor, an electric control unit, which contains a memory for storing digital data, a driver unit (motor controller), which determines electrical signals for controlling the power-assistance motor in accordance with a target engine torque that was transmitted to the driver unit and outputs said electrical signals to the power-assistance motor, at least one sensor device for determining a control variable, for example a manual torque, introduced into the control means, wherein a preset value for a engine torque of the power-assistance motor is determined in the control unit with the aid of the control variable, wherein in addition, an upper threshold value for the target engine torque is stored in a limiting element, and for a case A in which the preset value exceeds the upper threshold value, the limiting element outputs the upper threshold value as a target engine torque to the motor driver unit, and for a case B in which the preset value does not exceed the upper threshold value, the limiting element outputs the preset value as a target engine torque to the driver unit.

The present invention relates to a control method for a steering system with electric power assistance having the features of the preamble of claim 1.

Motor vehicles with electric power steering generally comprise a steering column which is connected via steering gear with the steered wheels of the vehicle. The steering column contains a torque sensor for the torque that the driver introduces into the steering. An electric servomotor is also provided, which drives the steering gear via a reduction gear and assists the driver in performing the steering. A control is necessary in order to ensure that the servomotor generates precisely the amount of power assistance necessary to achieve a certain steering characteristic. For example, at low speeds and high torques a high level of power assistance should be generated in order to take the burden off of the driver when parking and at higher speeds and lower torques a low level of power assistance should be generated in order that the driver experiences a direct steering feel. A very important aspect is that malfunctions of the sensor, the control system or the electric motor do not lead to the electric motor performing undesired and unexpected steering manoeuvres.

The general object of control systems therefore is to provide interference-free functioning of the electric power steering. German patent specification DE 100 636 05 B4 provides that an electric motor is controlled via a driver. In addition a motor driver limiting device is provided in order to limit the driving of the electric motor. The driver limiting device switches off completely if a fault is detected in the motor driver. During vehicle operation this results in a total and sudden loss of the power assistance. This can have an irritating effect for the driver.

The German published application DE 198 21 220 A1 provides that the motor current is limited by an upper threshold value. In this way excess power assistance can be prevented. This limit is determined on the basis of the back electromotive force. Thus it is not possible, however, to compensate for instabilities within the controller itself. Instabilities can be attributed to various causes. The driver for example may unnecessarily turn the steering wheel back and forth. The road surface may be uneven, introducing periodic disturbances into the control system. The steered wheels of the motor vehicle may have an imbalance, likewise generating periodic interferences. Such instabilities cannot be compensated by limiting the motor current. The publication does not provide for any lower limit of the motor current either, so that the steering assistance torque can tend to zero. In the case described this corresponds to a complete and sudden loss of the power assistance.

A similar solution is described in U.S. Pat. No. 6,404,156 B1. Here limitation of the power assistance is brought about by upper and lower threshold values for the motor current. In the chain of electronic control, comprising the various sensors (torque sensors, speed sensor), a booster with phase compensation, a motor driver and the servomotor itself, at the booster and phase compensation stage the sensor values are processed without any preset restriction and delivered to the driver. The driver limits the range of values of the control signal for driving the electric motor in order to prevent excessively high and low motor currents and thus excessively high or low steering assistance torques.

Steering systems according to the prior art described have the following restrictions on the driving dynamics:

The steering systems according to DE 100 636 05 B4 and DE 198 21 220 A1 limit the range of values for the possible motor current in certain driving situations. In this way the maximum possible motor output and thus the maximum power assistance are also limited. In extreme situations such as for example evasive manoeuvres or also extreme and unforeseeable influences on the steered wheels this can lead to a higher manual torque being exerted on the steering wheel than is actually necessary on the basis of the driving situation and the technically available output of the servomotor. In many situations, therefore, steering systems do not fully utilise the dynamic range of the servo unit.

According to a further exemplary embodiment of the steering equipment according to U.S. Pat. No. 6,404,156 B1 the sensor signal that is delivered by the torque sensor of the steering equipment to the control system is limited as a function of certain parameters. As a result of this, information on extreme values of the torque sensor, which for example can occur if the driver operates the steering wheel with a very high manual torque (evasive manoeuvre) or if extreme influences act upon the steering (potholes, hitting the kerb, sudden tyre defect), is lost. On the basis of the previously limited sensor signal the control system is unable to recognise such situations and therefore cannot respond appropriately to them. An appropriate response in the stated cases would be to increase the steering assistance torque to the technically possible maximum value, in order to keep the manual torque on the steering wheel within predefined limits. If the sensor signal is limited before it reaches the control system this is not possible. As a result neither does this steering equipment utilise the full dynamic range of the servo drive that is technically available.

The object of the present invention is therefore to provide a control method for electric power steering, which even in critical steering situations maintains stable driving and increases fault tolerance. In particular a control for electric power steering is to be provided which is able to fully utilise the available dynamic range of the servo drive and which is insensitive to system oscillations.

This object is achieved by a control method with the features of claim 1. The other claims describe advantageous further development of the invention.

In a control method for a steering system with electric power assistance, comprising:
a control means, for example a steering wheel, controllable by a driver,
an electric power assist motor,
an electric control unit, which includes a memory for storing digital data,
a motor driver unit (motor controller) that based on a target engine torque, sent to the motor driver unit, determines and delivers electrical signals for controlling the electric power assist motor,
at least one sensor device for determining a control variable introduced into the control means, for example a manual torque,
wherein in the control unit with the help of the control variable a preset value for a engine torque of the electric power assist motor is determined,
it is also provided that
in a limiting element an upper threshold value for the target engine torque is stored, and
for a case A, in which the preset value exceeds the upper threshold value, the limiting element delivers the upper threshold value as the target engine torque to the driver unit, and
for a case B, in which the preset value does not exceed the upper threshold value, the limiting element delivers the preset value as the target engine torque to the motor driver unit.

This allows both the sensor signal to be evaluated across its full range of values and the motor driver unit to impinge upon the motor with its full available output current so that in extreme situations the maximum available dynamics of the steering system can be utilised. The limiting element is arranged in the signal path between the controller, which determines the preset value for the target engine torque, and the motor controller. The limiting element can however also be physically combined with the control system in a single unit. Here it is immaterial whether the limitation is achieved purely by software engineering or purely by hardware engineering or as a combination of software and hardware engineering.

If it is also provided that
in the memory a lower threshold value for the target engine torque is stored, the value of which is lower than the upper threshold value, and
for a case D, in which the preset value falls below the lower threshold value, the limiting element delivers the lower threshold value as the target engine torque to the driver unit, and
for a case E, in which the preset value does not fall below the lower threshold value and does not exceed the upper threshold value, the limiting element delivers the preset value as the target engine torque to the motor driver unit,
   it can also be prevented that the target engine torque because of incorrect information, for example from the sensors, causes the power assistance being lost suddenly and unexpectedly for the driver.

If an upper intermediate value and a lower intermediate value are defined, wherein the upper intermediate value is smaller than the upper threshold value and the lower intermediate value is greater than the lower threshold value, and in an area between the upper intermediate value and the upper threshold value the target engine torque is determined from the difference between the preset value and the threshold value, a damped approximation of the target engine torque to the upper threshold value can be achieved. The same applies for the approximation to the lower threshold value, if in an area between the lower intermediate value and the lower threshold value the target engine torque is determined from the difference between the preset value and the lower threshold value. This reduces the tendency to oscillation of the controller. This continuous transition (=damped transition) from the unlimited to the preset value limited by the upper and/or lower threshold value for the engine torque ensures that the driver, upon encountering critical states, experiences a slower deterioration of the assistance function and can adjust intuitively to this. Such a continuous transition is when travelling on poor quality roads also in particular advantageous, however, in steering systems without a steering wheel, such as those which use control sticks or joysticks.

Accordingly, for a case C, in which the preset value (T_{RM}) takes a value that is between the upper intermediate value (max1) and the upper threshold value (max), it is provided that as the target engine torque a value is determined which results from the preset value minus a correction value which is calculated from the distance between the preset value and the upper threshold value, and that this value is delivered directly or indirectly to the motor controller (25).

For a further case F, in which the preset value (T_{RM}) takes a value that is between the lower intermediate value (min1) and the lower threshold value (min), it is provided that as the target engine torque a value is determined which results from the preset value plus a correction value which is calculated from the distance between the preset value and the lower threshold value, and that this value is delivered directly or indirectly to the motor controller (25).

The approximation to the threshold value can take place proportionally to the square or logarithmically in order to achieve constant and preferably constantly differentiable transitions. Here the approximation to the threshold value can also be regulated via a PD controller, which uses the distance of the preset value from the respective threshold value and the change in this distance for the control. It can further be provided that the distance between the preset value and the respective adjacent threshold value is introduced with a weighting factor into a transition function in order to determine the target engine torque. A steering angle speed can also be determined and introduced with a weighting factor into the transition function. Both result in an adaptation of the approximation to the threshold values with damping as a function of the driving condition.

This applies in particular if the difference between the upper intermediate value and the upper threshold value and/or between the lower intermediate value and the lower threshold value is dependent upon the vehicle speed and/or other vehicle parameters.

The limiting values for the maximum and minimum target engine torque can be designed to be variable and can thus be matched to the parameters of the driving situation, if the upper and/or the lower threshold value is dependent upon the control variable introduced. In particular the threshold values can be dependent upon the vehicle speed and/or other vehicle parameters, such as for example, but not exclusively, the steering angle speed, the steering angle, the available power supply or the yaw rate.

At higher speeds the control approximates to a control system which undertakes no or only minor control interventions if at high vehicle speeds the distance between the upper threshold value and the lower threshold value is smaller than at low vehicle speeds.

Where threshold values are frequently reached this may be an indication that there are fault conditions in the steering system. Therefore in an advantageous further development the frequency of reaching the upper and/or lower threshold values for the preset value of the engine torque is evaluated. Advantageously the control processes are limited as a precaution, if within a predefined length of time the frequency of reaching the upper and/or lower threshold value reaches or exceeds a certain level. In this case the upper or the lower threshold value, or both, is or are changed in such a way that the permissible range between the threshold values is reduced. This may be necessary, for example, if the threshold values are not reached as a result of an external influence or a driver intervention, but because faulty sensor signals lead to this.

Furthermore, in the event of temporary interferences, it may be advantageous if the threshold value(s) is (are) reset to the original value(s), if during a second preset length of time the threshold value is no longer reached.

In the following an exemplary embodiment of the present invention is described in more detail using the drawing. This shows as follows:

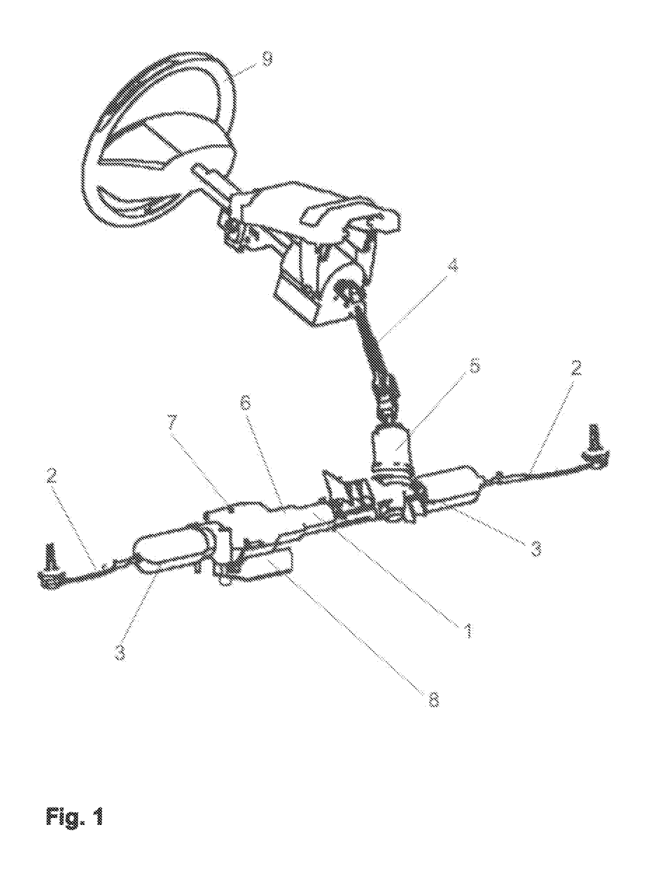

FIG. 1: an electric power-assisted steering system in a perspective view;

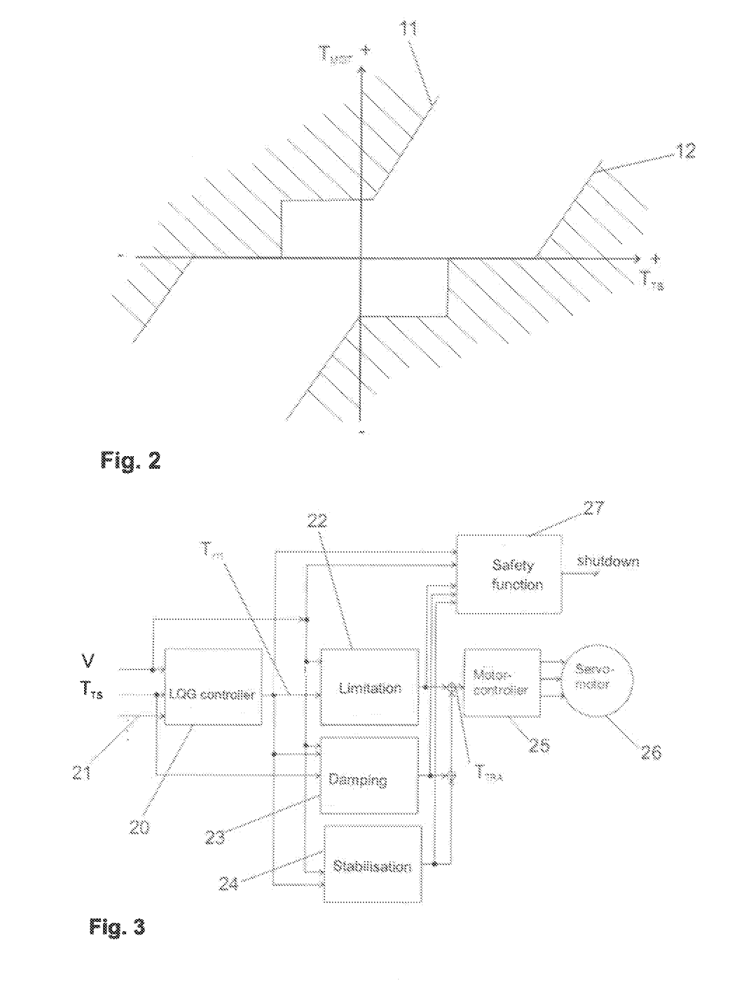

FIG. 2: a range of values for the engine torque as a function of the torque sensor signal for the steering according to the invention;

FIG. 3: a block diagram of the electric power steering;

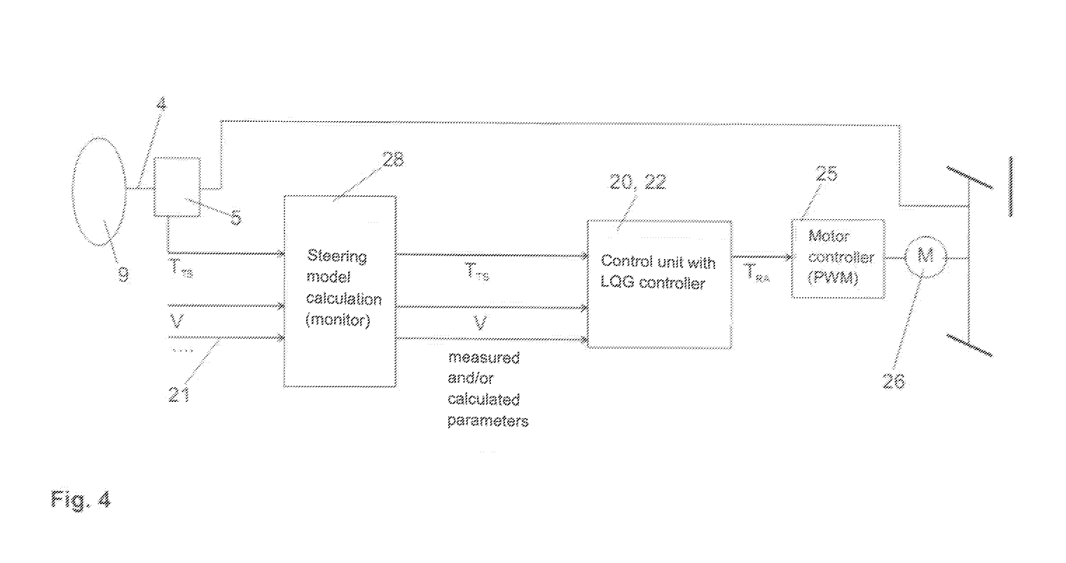

FIG. 4: a schematic representation of the steering system as a whole, with steering wheel, torque sensor, control unit, motor driver, motor and steering gear with the steered wheels;

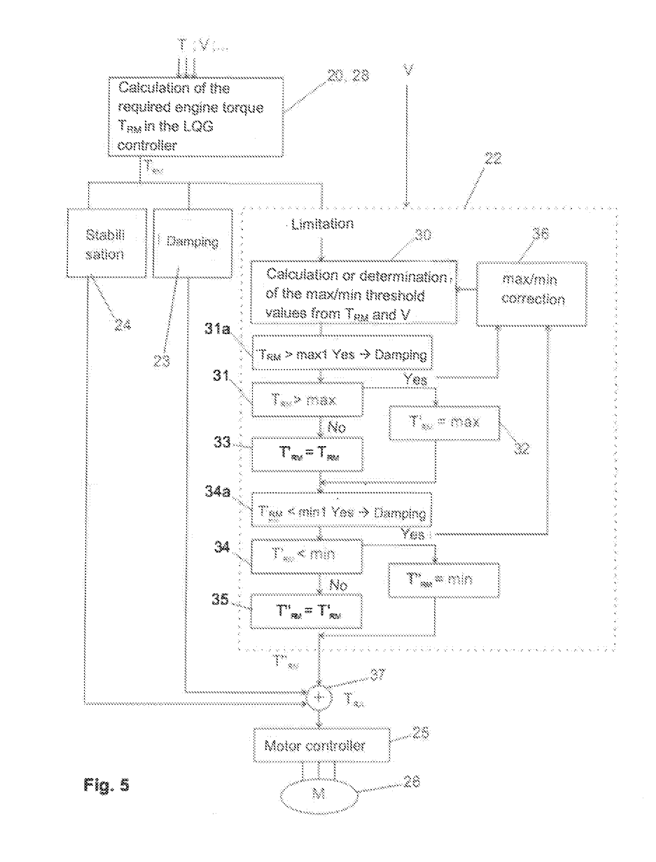

FIG. 5: the programme sequence of the control system of the electric power steering in the form of a flow diagram;

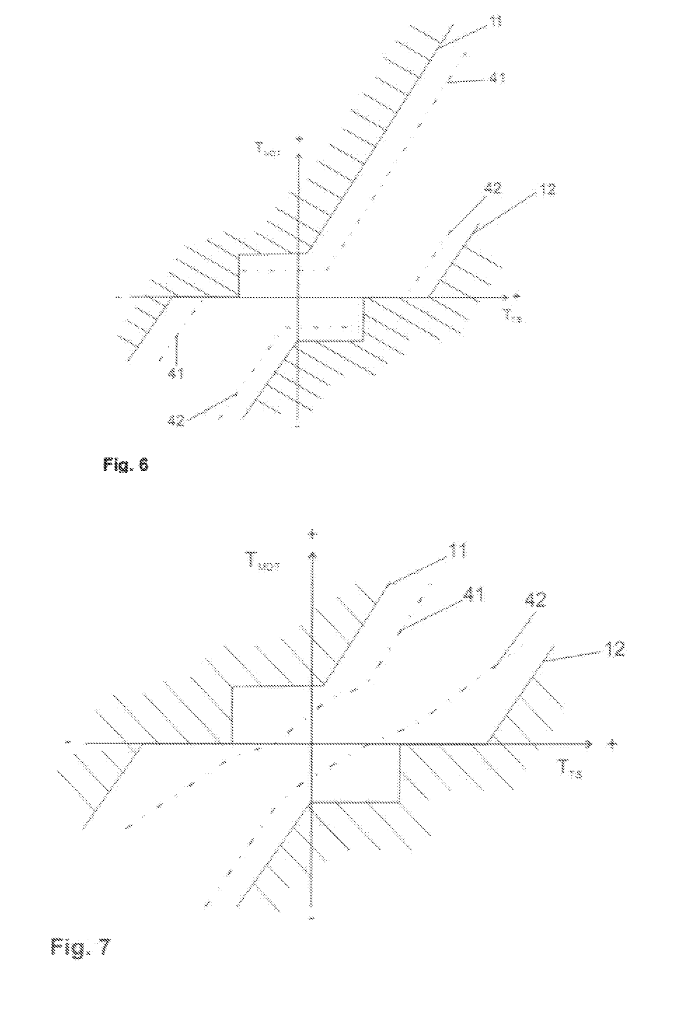

FIG. 6: an example of a permitted range of values of the torque requirement signal T_{RA} as a function of the torque sensor signal T_{TS} with an example of the behaviour of an upper and lower intermediate value, after which the transition to the limitation is initiated;

FIG. 7: a further example of a permitted range of values of the torque requirement signal T_{RA} as a function of the torque sensor signal T_{TS} with a behaviour of an upper and lower intermediate value, that differs from FIG. 7, after which the transition to the limitation is initiated;

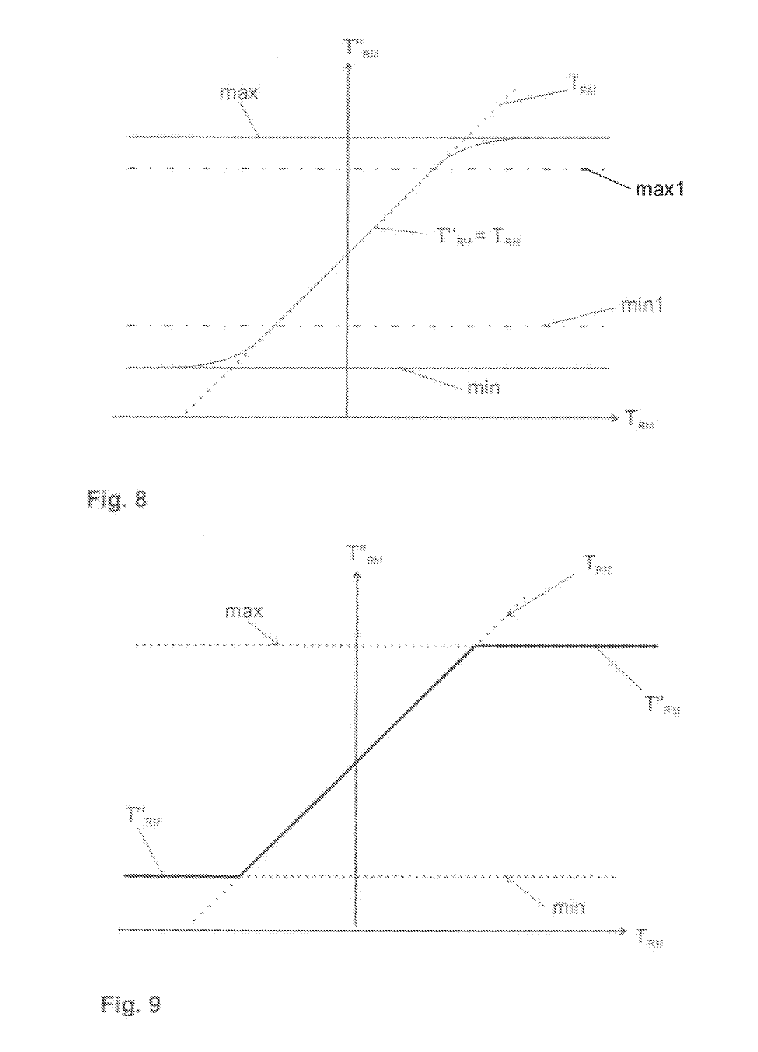

FIG. 8: a representation of the behaviour of T″_{RM} within the permitted range of values with damped transition; and

FIG. 9: a representation of the behaviour of T″_{RM} within the permitted range of values without damped transition;

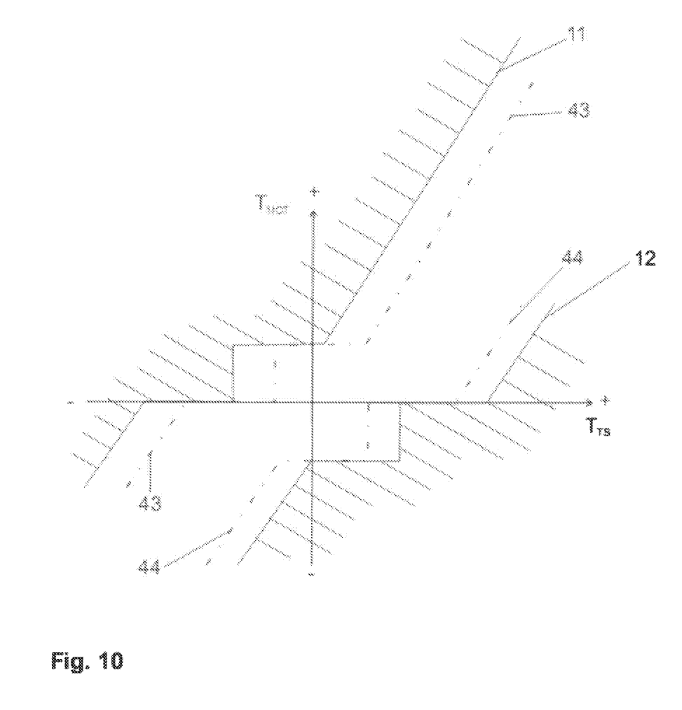

FIG. 10: a representation of the permitted range of values with a possible restriction of this range of values.

FIG. 1 shows a motor vehicle power steering system with a steering gear 1, in which a steering rack is arranged in the longitudinal direction of the steering gear 1 in a movable manner. The steering rack carries two track rods 2, which are connected by means of ball-and-socket joints with the steering rack. The ball-and-socket joints are arranged in bellows 3 encapsulated against environmental influences. The track rods 2 are for their part connected with steering knuckles of the steered wheels. A displacement of the steering rack in the steering gear 1 thus leads in a known manner to a pivoting of the steered wheels and thus to a steering manoeuvre of the motor vehicle.

By means of a steering shaft 4 a torque is introduced into the steering. A torque sensor 5 detects the torque introduced into the steering shaft 4. In order to provide power assistance for the steering process and thus to reduce the manual torque to be applied by the driver a servo drive is incorporated in the steering gear 1. The servo drive comprises a motor housing 6, a gear housing 7 and a control system 8. The motor and the gear cannot be seen in this representation.

During operation, in prior art fashion the driver operates a steering wheel 9 which then via the steering shaft 4 and a pinion brings about a displacement of the steering rack in the steering gear 1. The torque detected in the torque sensor 5 is monitored and in order to simplify the steering manoeuvre the servo motor is impinged upon through the control system 8 with current, in order to assist the steering movement of the driver.

Multiple possibilities exist for controlling and regulating the power assisted steering. Thus the control system 8 can in the simplest of manners provide power assistance via the servomotor, in that the required engine support torque is simply proportional to the sensor torque determined. In practice power assisted steering systems are in many cases controlled via operating maps which are stored in a memory in the form of a table of values or by the saving of analytical functions. A value range for the result of such a control is shown in FIG. 2.

FIG. 2 indicates in a system of coordinates, in the horizontal, possible values for a torque signal T_{TS}, which is indicated by the torque sensor 5 as a function of the torque introduced into the steering wheel 9. In the vertical axis a possible engine torque T_{MOT} is shown, which is requested from the motor driver on the basis of the torque signal T_{TS}. An upper characteristic curve 11 and a lower characteristic curve 12 provide upper and lower threshold values to the signal T_{MOT}. The hatched areas above the characteristic curve 11 and below the characteristic curve 12 are prohibited areas, which the engine torque T_{MOT} should not reach. From the characteristic curve 11 the respective maximum value max is determined accordingly, which must be delivered for the value delivered to the motor controller for the torque requirement signal T_{RA}. From the characteristic curve 12 the respective minimum value min is determined accordingly, which must be delivered for the value delivered to the motor controller for the torque requirement signal T_{RA}. The area between the characteristic curves 11 and 12 is the permitted value range in which the motor signal T_{moT} should be located. For a given torque signal T_{TS} the motor signal T_{MOT} can take various values. These values can, for example, be dependent upon the vehicle speed V.

FIG. 3 is a block diagram of a power steering according to the invention. In the block diagram the vehicle speed V and the signal T_{TS} from the torque sensor 5 provide the input signals which are introduced into a controller 20. Further input signals can be introduced at 21, for example the ambient temperature, the yaw rate or similar. From the input values the controller 20 calculates a signal for the required engine torque T_{RM} and the torque signal T_{TS} is fully available to the controller and can therefore be evaluated totally. The controller 20 likewise generates a signal T_{RM}, which comprises the complete possible range of values and thus has a maximum possible dynamic scope.

A limiting element 22 receives as an input signal the vehicle speed V_{O} and the required engine torque T_{RM}. The limiting element 22 calculates from this, using a table or based on analytical functions, a maximum value and a minimum value, which the engine torque must take for the preset parameter values. In relation to FIG. 2, the limiting element 22 ensures that the required torque value does not enter the prohibited hatched areas of the diagram from FIG. 2. The signal limited in this way by the limiting element 22 is combined with, for example added to, signals not described in more detail from a damping element 23 and from a stabilisation element 24. The combination then provides a requirement signal T_{RA} for the actual steering assistance torque required. The signal T_{RA} is delivered to a motor controller 25 which finally impinges upon a servomotor 26 with current. The signals generated are also delivered to a safety function 27 which in the extreme case can bring about a shutdown of the power assisted steering.

In order to achieve the target broad dynamic range of the power assisted steering it is important here that the signal T_{TS} and the output signal of the motor controller 25 can cover the full available dynamic range, so that the full bandwidth of the signal T_{TS} picked up by the torque sensor can be evaluated. Apart from this, the motor controller, the output value range of which is not limited, can call upon the maximum possible steering assistance performance of the servomotor 26. The limitation as a function of speed or of other parameters of the required power assistance torque T_{RA} takes place in the limitation element 22.

FIG. 4 shows the controlled system of the power steering according to the invention in schematic view.

The handwheel 9 is connected by means of the spindle 4 with the torque sensor 5. The torque signal T_{TS} enters the unit shown here as an integrated module, which comprises the controller 20 and the limiting element 22. Furthermore, the vehicle speed V is supplied to the unit 20, 22. Further signals 21, as described above, are taken into account by the control system.

As a function of the input variables the unit 20, 22 provides the torque requirement signal T_{RA} to the motor controller or motor driver 25 which in turn impinges upon the servomotor 26 with current. Via a gear the servomotor 26 drives the steering rack and thus the steered wheels of the vehicle. The road has a reaction via the steered wheels on the steering shaft 4. In the torque sensor 5 therefore not only do torque signals occur based on an operation of the steering wheel 9, but also based on the reaction of the road via the wheels on the steering shaft 4. In particular torques can also occur at the torque sensor 5 if the steering wheel 9 is not operated or even if the driver lets go of it. The invention is not limited to a controlled system as shown in FIG. 4, however. The invention is also applicable in the case of steer-by-wires, where there is no mechanical intervention by the steering wheel 9 on the wheels of the motor vehicle. In this case the monitor, that is to say the steering model calculation unit (the calculation module 28 explained below) would deliver corresponding signals to an actuator not shown here, which counteracts the steering wheel movement with a corresponding reaction torque.

In a particularly advantageous further development the control takes place with an LQG control algorithm, as described in the lecture entitled “Optimale Regelung einer elektromechanischen Servolenkung” (Optimum Control of Electromechanically Assisted Steering) given to the 5th VDI Mechatronik Conference 2003 in Fulda (7-8 May 2003) by Hermann Henrichfreise, Jürgen Jusseit and Harwin Niessen.

In the preferred exemplary embodiment, as shown in FIG. 4, between the transmission of the pure sensor signals T_{TS} and V a further calculation module 28 is incorporated for the mathematical model of the steering used. The calculation module 28 contains the mathematical model of the steering used and works as a kind of state monitor. From the data available at the input for the torque sensor signal T_{TS}, the vehicle speed V and other possible input data 21, the calculation module 28 can calculate a plurality of parameters and “substitute measured values”, without these having to be measured with separate sensors. These data include, for example, the friction that occurs within the steering system and which cannot be readily measured. Friction can indeed be taken into account with a steering system according to the invention, however.

In this way measured values and calculated “substitute measured values” can be supplied to the controller 20 for calculation of the preset value for the engine torque.

FIG. 5 illustrates the process sequence in the power steering according to the invention, which is carried out in order to calculate the manual control of the servomotor 26.

The input signals T_{TS} and V are evaluated in a controller and in prior art fashion a required engine torque is calculated from this which is output as the signal T_{RM}. The control unit 20 is known from the prior art. It can for example work according to the principle of the control unit that is described in European patent specification EP 1 373 051 B1. This control unit works as described above as a so-called state monitor, which from input variables calculates various output variables and internally used data. In the known control unit, which can correspond to the control unit 20, the mathematical model of the steering is stored, which contains the various dependencies between the measured values and the non-measured state values. It can, however, be provided that the control unit 20 takes the form of a relatively simple control unit in the form of a PID controller or similar.

The engine torque signal T_{RM} is then passed to the already mentioned components, namely the damping part 23 and the stabilisation part 24. In parallel the limiting element 22 also receives this signal. The further input signal, the vehicle speed V, similarly goes to the limiting element 22 which is shown here as a broken line.

In the limiting element 22 in a calculation step 30 from a table or using analytical functions the permitted threshold values (max upper threshold value and min lower threshold value) of the engine torque requirement signal T_{RM} are now calculated. The actual signal T_{RM} delivered by the control unit 20 is then compared in a first step 31a with the upper intermediate value max1. If this value max1 is reached a damping of the value T_{RM} takes place accordingly, as described in the following. Otherwise the value T_{RM} remains unchanged. The result is delivered as T_{RM} to the next step. In the second step 31 the value T_{RM} is compared with the upper threshold value max. If T_{RM} is greater than max, then T′_{RM}=max is set. If T_{RM} is smaller than the threshold value max, then T′_{RM}=T_{RM} remains unchanged. This is illustrated in calculation steps 32 and 33. The signal with this upper threshold value is delivered to step 34a, in which the signal T_{RM} is compared with the lower intermediate value min1. If T′_{RM} is smaller than the lower intermediate value min1, then a corresponding damping of this value T′_{RM} takes place, as described in the following. Otherwise the value T′_{RM} remains unchanged. The result is passed as T′_{RM} the next step 34, in which the signal T_{RM} is compared with the lower threshold value. If T′_{RM} is smaller than the lower threshold value min, then T′_{RM} is replaced by min. This takes place in step 35.

If it is found in step 34 that T′_{RM} is not smaller than min, then T″_{RM}=T′_{RM} is output unaltered.

If in calculation steps 31 or 34 it is found that a threshold value max or min has been reached, this information is passed on to a correction element 36. The correction element 36 checks how often the threshold value max or min has been reached or exceeded. Depending on how it is programmed for the respective steering system the correction element 36 can then calculate new threshold values max and min and calculate corresponding new upper and lower intermediate values max1 and min1, which deviate from the original threshold values or intermediate values. These new threshold values and intermediate values are then used for future calculations in calculation step 30. For example, in the event of frequent exceeding of a threshold value it may be the case that the torque sensor 5 is defective and is delivering torque values T_{TS} that are too high, too low or which oscillate. In this case the correction element 36 can provide that the threshold values max and min are approximated to one another, so that the output signal T″_{RM} of the limitation element 22 is further limited with regard to the possible range of values. Oscillations in the input signals are then delivered to the motor controller only to a limited extent.

The correction element 36 is also programmed in such a way that in the absence of threshold values being exceeded the threshold values max and min are reset to the original values. In practice the correction element 36 can be programmed in such a way that a narrowing of the threshold values takes place if within five seconds a plurality of threshold value exceedances are detected. Resetting of the threshold values then takes place if the previously narrowed threshold values are no longer reached or exceeded for a preferably greater length of time, for example 40 seconds. In this way the response of the correction element 36 to temporary interference does not have a lasting effect on the behaviour of the steering system.

As the output signal of the limiting element 22 therefore a signal is generated which represents the unchanged signal T″_{RM}=T_{RM} if in particular in steps 31 and 34 it is found that T_{RM} is smaller than max and greater than min and in steps 31a and 34a it is found that T_{RM} is smaller than max1 and greater than min1. If in steps 31 or 34 the threshold values are exceeded upwards or downwards, then the respective current threshold value is delivered as an output of the limiting element 22.

This output signal T″_{RM} is delivered to an adder 37, which also contains the output values of the damping element 23 (which should not be confused with the damping which itself takes place in the limiting element in steps 31a and 34a) and of the stabilisation element 24. The latter can have positive or negative signs and are combined in the adder 37 to make a torque requirement signal T_{RA}. The signal T_{RA} is then delivered to the motor controller 25, which energises the servomotor 26 accordingly.

It is nevertheless conceivable and possible to replace the addition of the output signals from the damping 23, stabilisation 24 and limitation 22 by another combination. For example, a multiplication or more complex function could be used for the combination.

It is also conceivable and possible for the output signal T″_{RM} to be delivered by the limitation 22 directly to the motor controller 25 as a torque requirement signal T_{RA}. In certain cases through the damped transition from calculated preset value for the engine torque signal T_{RM} to the limited actual output signal T″_{RM} a sufficient stability and safety for the steering system can be provided and the additional damping and stabilisation functions can be dispensed with.

It should be stressed that the output signal T″_{RM}=T_{RM} of the control unit 20 remains unchanged by the limiting element 22, provided that the threshold value and intermediate values max, max1 and min1, calculated in step 30 are not exceeded. Thus for the signal path T_{TS} to T_{RA} the entire possible dynamics are available.

The limitation that takes place in steps 33 and 35, evaluates the full information range of the torque sensor T_{TS} and the other input data of the control unit 20. In the case of limitation also the torque requirement signal T_{RA} delivered to the motor controller 25, as a result of the added damping-stabilisation components, can be greater than or smaller than the upper limits max and min from the limitation element 22, so that the motor controller 25 and accordingly the servomotor 26 can develop a higher level of dynamics than could be envisaged simply on the basis of the limiting element 22.

FIG. 6 and FIG. 7 provide an illustration of the permitted range of values as in FIGS. 2 and 10. In FIG. 7 a dot-dash line 41 identifies an upper intermediate value, and dot-dash line 42 a lower intermediate value. The intermediate values 41 and 42 are transition values, at which the torque requirement signal T_{RA} is not calculated directly from the signal T_{RM}, and in fact not even if the signal T_{RM} is within the limits max and min.

With the exemplary embodiment described here a check is made that the input signals of the limiting element 22 achieves the intermediate value 41 or 42. If this is the case, the signal delivered to the motor controller 25 is calculated from the difference between the intermediate value 41 and the upper threshold 11 or the difference between the intermediate value 42 and the lower threshold 12. In this way upon approximation to the threshold values 11 or 12 the signal delivered to the adder 37 is smaller. In the ideal case an asymptotic approximation to the threshold values 11 and 12 takes place so that in normal operation these cannot be exceeded. Strictly speaking therefore in the particularly preferred case the steps 31 and 32, in which the comparison with the upper threshold max and lower threshold min takes place, would be superfluous since in the damping in step 31a or 34a the damping in the particularly preferred case would take place in such a way that the transition curve from the preset value T_{RM} to the output value T″_{RM} results in a constantly differentiable curve, that is to say a curve without jumps, or even better a curve whose derivation is also without jumps. In the simplest case a correction value, which is determined by the difference between the preset value T_{RM} and the threshold value, in the case of reaching the upper intermediate value max1 is subtracted from the preset value T_{RM} and in the case of reaching the lower intermediate value min1 is added to the preset value T_{RM}. The correction value here can be described by linear, logarithmic or exponential functions. Here the correction value preferably has a value of zero in the case that the preset value T_{RM} is exactly equal to one of the two intermediate values max1, max2, and takes a higher value in the case of the threshold value being reached. It is even conceivable and possible, where the threshold value is exceeded, to increase the correction value further, so that the changed preset value never exceeds the threshold value. This approach is illustrated in more detail in FIG. 8 below.

FIG. 8 shows the behaviour of the signal T″RM at the output of the limiting module 22 for the exemplary embodiment described in FIG. 7, in which intermediate values 41 and 42 are provided for when approximating to the threshold values max or min. An illustration is given of how the value T″_{RM} upon approximation to the threshold values max and min does not increase linearly as far as the threshold values, but from the intermediate values 41 and 42 is approximated to asymptotically. Such transfer functions, which can be used for calculating the damping, based on the exponential or logarithmic function are known and are therefore not described further here.

FIG. 9 shows the other case, as has already been described in connection with FIG. 5. Here, upon reaching the threshold values max or min, the signal T″_{RM} comes up against a ‘hard’ stop. This results in the signal behaviour in a constant, but not constantly differentiable component which could result in system oscillations. In the exemplary embodiments of FIGS. 7 and 8 this is avoided.

FIG. 10 shows the range of values for the engine torque (T_{MOT}) as a function of the torque sensor signal T_{TS}. The solid lines 11 and 12 have already been described in FIG. 2. The dot-dash lines 43 and 44 identify the limited upper threshold value and the limited lower threshold value following processing by the correction element 36 in FIG. 5. The permitted range of values for the engine torque as described under FIG. 5 in the presentation of the method of working of the correction element 36, is between the lines 43 and 44. The range of values is consequently further restricted.

### KEY

1. Steering gear
2. Track rod
3. Bellows
4. Steering shaft
5. Torque sensor
6. Motor housing
7. Gear housing
8. Control system
9. Steering wheel
11. Upper characteristic curve
12. Lower characteristic curve
20. Controller
21. Signal
22. Limiting element
23. Damping element
24. Stabilisation element
25. Motor controller
26. Servomotor
27. Safety function
28. Calculation module
30. Calculation step
31. Calculation step
32. Calculation step
33. Calculation step
34. Calculation step
35. Calculation step
36. Correction element
41. Upper intermediate value
42. Lower intermediate value
43. Limited upper threshold value
44. Limited lower threshold value

1. A control method for a steering system with electric power assistance, the steering system including
a control means controllable by a driver,
an electric power assist motor,
an electric control unit, which includes a memory for storing digital data,
a motor controller that based on a target engine torque, sent to the motor controller, determines and sends out electrical signals for controlling the electric power assist motor,
at least one sensor device for determining a control variable introduced into the control means, and
the method comprising:
determining, in the control unit, with the help of the control variable, a preset value for an engine torque of the electric power assist motor; and
using an upper threshold value and an upper intermediate value for the target engine torque stored in a limiting element,
for a case A, in which the preset value exceeds the upper threshold value, delivering, by the limiting element, the upper threshold value as the target engine torque directly or indirectly to the motor controller,
for a case B, in which the preset value does not exceed the upper intermediate value, delivering, by the limiting element, the preset value as the target engine torque directly or indirectly to the motor controller, and
for a case C, in which the preset value takes a value that is between the upper intermediate value and the upper threshold value, determining the target engine torque by subtracting from the preset value a correction value which is calculated from a difference between the preset value and the upper threshold value, and delivering the determined target engine torque directly or indirectly to the motor controller.

2. The control method according to claim 1, wherein a lower threshold value for the target engine torque is further stored in the limiting element, wherein the lower threshold value has a value that is lower than the upper threshold value, and wherein the method further comprises:
for a case D, in which the preset value falls below the lower threshold value, outputting, by the limiting element, the lower threshold value as the target engine torque to the motor controller, and
for a case E, in which the preset value does not fall below the lower threshold value and does not exceed the upper threshold value, outputting, by the limiting element, the preset value as the target engine torque to the motor controller, and
for a case F, in which the preset value takes a value that is between the lower intermediate value and the lower threshold value, determining the target engine torque by adding to the preset value a correction value which is calculated from a distance between the preset value and the lower threshold value, and delivering the determined target engine torque directly or indirectly to the motor controller.

3. The control method according to claim 1, wherein the upper threshold value is dependent upon the control variable.

4. The control method according to claim 1, wherein the upper threshold value is dependent upon vehicle speed and/or one or more other vehicle parameters selected from the group consisting of steering angle speed, steering angle, available power supply or yaw rate.

5. The control method according to claim 2, wherein at high vehicle speeds, the distance between the upper threshold value and the lower threshold value is smaller than at lower vehicle speeds.

6. The control method according to claim 2, further comprising: measuring, during a preset length of time, a frequency of reaching the lower and upper threshold values is measured; and
performing at least one of reducing the upper threshold value or increasing the lower threshold value, if within the preset length of time, the upper threshold value and/or the lower threshold value is reached more than a preset number of times.

7. The control method according to claim 6, wherein the upper threshold value and/or the lower threshold value is reset to a respective original value if, for a second preset length of time, the upper and/or the lower threshold value is no longer reached.

8. The control method according to claim 2, wherein an approximation to the lower threshold value is proportional to a square or logarithmic function.

9. The control method according to claim 2, wherein an approximation to the lower or upper threshold value is controlled by means of a PD controller, which uses a distance of the preset value from the respective threshold value and a change in this distance as control inputs.

10. The control method according to claim 1, wherein a distance between the preset value and a respective threshold value is introduced with a weighting factor into a transition function for determining the target engine torque.

11. The control method according to claim 10, further comprising calculating a steering angle speed, wherein the steering angle speed is introduced along with a weighting factor into the transition function.

12. The control method according to claim 2, wherein a difference between the upper intermediate value and the upper threshold value and/or between the lower intermediate value and the lower threshold value is dependent upon vehicle speed and/or at least one other vehicle parameter.

13. The control method according to claim 1, further comprising: combining an output value for the target engine torque with an output signal of a stabilisation and an output signal of a damping; and delivering a result of said combining to the motor controller as a preset signal.

14. The control method according to claim 2, wherein the lower threshold value is dependent upon the control variable.

15. The control method according to claim 2, wherein the lower threshold value-is dependent upon vehicle speed and/or one or more other vehicle parameters selected from the group consisting of steering angle speed, steering angle, available power supply or yaw rate.
